(19) United States
(12) Patent Application Publication
(10) Pub. No.: US 2008/0071584 A1
(43) Pub. Date: Mar. 20, 2008

(54) Method for Using a Survival Risk Insurance Policy as Part of a Separate Account or General Account Investment Option

(76) Inventor: Kiritharan Parankirinathan, New Fairfield, CT (US)

Correspondence Address: MARK S. NOWOTARSKI, 30 GLEN TERRACE, STAMFORD, CT, 06906, US

(21) Appl. No.: 11/942,751

(22) Filed: Nov. 20, 2007

Related U.S. Application Data
(63) Continuation-in-part of application No. 11/197,251, filed on Aug. 4, 2005.
Application No. 11/197,251 is a division of application No. 10/743,201, filed on Dec. 22, 2003, now Pat. No. 6,999,935.
(63) Continuation of application No. 60/878,369, filed on Jan. 3, 2007.
(60) Provisional application No. 60/507,170, filed on Sep. 30, 2003.

(51) Int. Cl. G06Q 40/00; G06F 17/00; G06F 17/10

(52) U.S. Cl. 705/4

(57) ABSTRACT

Survival risk insurance is purchased by a separate account in which variable life insurance policies are invested in order to assure the benefits of such variable life insurance policies will be available per assumptions made in a funding strategy. Alternatively, survival risk insurance may be purchased by the general account of a life insurance company to offset guarantees made in the insurer's traditional life insurance policies to pay benefits per a death benefit schedule established at the time such life insurance was issued. Such funding strategy is a strategy that relies on the death benefits of such variable or traditional life insurance policies being paid according to a schedule projected by a modeling program.

### CROSS-REFERENCE TO RELATED APPLICATION

The instant application is a continuation in part and claims the benefit of pending U.S. non-provisional patent application entitled “Survival Risk Insurance”, Ser. No. 11/197,251, filed Aug. 4, 2005. Said non-provisional patent application “Survival Risk Insurance” is a divisional of U.S. non-provisional patent application “Method of Calculating Premium Payment to Cover the Risk Attributable to Insureds Surviving a Specified Period”, Ser. No. 10/743,201 filed Dec. 22, 2003, now U.S. Pat. No. 6,999,935. Said non-provisional patent application “Method of Calculating Premium Payment to Cover the Risk Attributable to Insureds Surviving a Specified Period” claims priority to U.S. provisional patent application “Method of Calculating Premium Payment to Cover the Risk Attributable to Insureds Surviving a Specified Period”, Ser. No. 60/507,170 filed Sep. 30, 2003.

The instant application also claims priority to pending U.S. provisional patent application entitled “Method for Using a Survival Risk Insurance Policy as Part of a Variable Life Insurance Policy Investment Option”, Ser. No. 60/878,369 filed Jan. 3, 2007.

All of said patent applications which the instant application claims priority to are incorporated herein by reference.

### FIELD OF INVENTION

The invention relates to the field of financial products and methods involving the provision of death benefits through life insurance. As used in this invention, the expression “life insurance” relates to the type of insurance policy that provides a death benefit if the life or lives insured by the policy die while the insurance policy is in force or effect.

### BACKGROUND OF THE INVENTION

Life insurance companies, through the issuance of life insurance policies, accept a transfer of the risk of adverse financial consequences which would be created when an insured life dies. Typically, the death of an individual creates adverse financial consequences for those who depend on future income or work contributions lost as a result of the individual's death. A life insurance policy is typically purchased to provide a beneficiary with a death benefit payment. The purpose of the death benefit payment is to provide the beneficiary with the means to offset, at least in part, the financial strain created by the unexpected or untimely early death of the insured life.

Life insurance pricing (that is, the determination of the premium charged by the insurance company for the acceptance of a stated death benefit risk) is based on a number of factors for which assumptions are made including: mortality, interest, expenses, and policy persistency. Policy persistency is the probability that the owner of a life insurance policy will choose to keep the policy in force by paying the premiums required as per the terms of the insurance contract. A policyholder who does not persist is said to have lapsed. An assumption with respect to lapse rates is typically the way persistency is incorporated into pricing calculations. Pricing assumptions are made prior to the issuance of a life insurance policy and are made relative to an entire class of insured lives and not with respect to individual insureds.

A number of different sets of pricing assumptions may be used. Assumption sets may vary by mortality class, type of distribution used, or by other characteristics commonly used to distinguish between classes of insured lives in the insurance industry. For example, different mortality assumptions may be applied to males versus females or to non-smokers versus smokers. Those skilled in the art are well aware of the fact that many other mortality class distinctions exist or are possible.

Also, different expense assumptions may be applied in different marketing situations. For example, insurance offered directly to the consumer in a direct marketing distribution channel versus insurance offered through a traditional agent based distribution channel will have different expense assumptions applied to reflect the different expected costs in these different marketing channels.

The interest rate assumptions used in pricing are important because they provide an adjustment for the timing differences between when cash goes into and out of the pricing calculations.

Persistency or lapse assumptions affect pricing calculations by creating an expectation with respect to the occurrence of cash flows which are dependent on the insurance policy being in force or effect.

When an individual insured applies for life insurance, an underwriting process is applied. The underwriting process determines the appropriate premium or underwriting class for the applicant based on an evaluation of the applicant's mortality characteristics and life expectancy. This is based in part on expertise the underwriter derived from prior training or experience. Life expectancy is the average number of years individuals in the same underwriting class can be expected to live. Maximum life expectancy is the highest age to which an individual in the underwriting class can be expected to live.

A life insurance policy may provide for some change in assumptions after the policy is issued. Such changes would modify the current charges or credits provided for in the policy for a class of insureds. These changes would result in a change in the overall cost of the life insurance for each insured in the same class of insureds. Such changes can only be justified by changes in experience after issue for the whole class to which an insured belongs and can only be applied to all insurance policies in the class. Typically the range of change allowed in a life insurance policy is limited by minimum or maximum guarantees made in the life insurance contract or policy relative to each assumption that may be changed.

One type of life insurance policy contains an endowment feature. This type of life insurance policy is called an endowment policy. With respect to such life insurance, the insurance company would pay an amount called the endowment benefit to the insured on the endowment date, for example age 65, if the insured survived to that date. The assumptions used in pricing a life insurance policy include an assumption regarding the maximum life expectancy of the lives insured. For many currently issued life insurance policies, this maximum life expectancy has been assumed to be age 100. More recent mortality tables used for life insurance pricing purposes are beginning to recognize longer maximum life expectancies, for example, age 120. These longer maximum life expectancies are made possible by improvements in health care and a general improvement in the health of the insured life population. Mortality tables developed for purposes other than life insurance pricing may have found it convenient to make assumptions regarding the maximum life expectancy different from age 100. For example, annuity products may use mortality tables for pricing purposes with a maximum life expectancy greater than age 100.

This maximum life expectancy age is often referred to as the maturity age for the life insurance policy. Any insured who survives to the end of this period can be thought of as reaching the ultimate endowment age. Typically, life insurance companies will make the death benefit of the life insurance policy available in some way to insureds who survive to the maturity age. One alternative is to pay an amount equal to the death benefit at the maturity age directly to the insured as an endowment benefit on the maturity date. Another alternative is for the insurance company to hold such a maturity age endowment benefit in an interest bearing account until such time as the insured actually dies. Then the benefit is paid as a death benefit.

In the past, the value in a life insurance policy was determined only by the contractual terms of the life insurance policy and confined to the relationship the owner of the policy had with the insurance company providing it. Recently, however, secondary markets for life insurance policies have developed in which a life insurance policy is purchased or the right to receive the death benefit is assigned to a third party by the owner of the policy in exchange for a fee or purchase price.

Examples of the operation of secondary markets can be seen in the life settlement market and viaticals. These markets involve life insurance policies on insured lives that become impaired after their policies were originally issued. In these markets, life insurance policies are purchased by third parties (that is, neither the owner of the policy nor the insurance company issuing the policy) or assigned to third parties for a fee or payment of some sort. For such payment the third party receives the right to receive the policy death benefit when the insured dies.

An impaired life is an insured life that develops an impairment after the life insurance policy was originally issued which reduces the insured's life expectancy. An impairment is any medical condition affecting the health status of the insured life which results in a higher mortality rate for the insured life than was reflected in the original mortality assumption made for the underwriting class the insured was assigned to when the insurance policy was issued. Because of the impairment acquired after original issuance of the policy, the likelihood of an earlier than expected death claim is increased. This situation may make life insurance policies covering such impaired lives worth more than the cash surrender value provided by the contractual terms of the policies.

The cash surrender value of a life insurance policy is the amount of money the life insurance company that issued the policy is willing to pay if the policy is lapsed or surrendered. A life insurance policy is lapsed if the owner of the policy stops paying the premiums required to keep the policy in force per the terms of the life insurance contract. For a typical term life insurance policy or whole life insurance policy, the policy lapses when the owner stops paying the contractually required premiums. A whole life insurance policy may have a cash value at the time it lapses which can be surrendered and paid to the policy owner in cash or applied by the policy owner under one of the nonforfeiture options contained in the policy contract.

For a universal life or variable universal life insurance policy with a flexible premium structure, the policy lapses when the cash value of the policy becomes insufficient to cover the insurance related charges specified in the policy contract. Typically this occurs because the policy owner has not made premium payments prior to the lapse sufficient to keep the policy cash value large enough to cover said charges.

A life insurance policy can be surrendered by an owner who voluntarily agrees to terminate the life insurance protection provided by the policy in exchange for the payment of the policy's cash surrender value. A life insurance policy's cash surrender value is the cash value of the policy defined in the life insurance contract adjusted for any amounts owed by the owner to the insurance company (for example, policy loans) or any additional amounts owed by the insurance company to the owner (for example, dividends). For universal and variable universal life insurance forms of insurance there may also be specifically stated surrender charges which are deducted to determine the cash surrender value.

Life insurance benefits may also be assigned to third parties in insurance marketing programs in which life insurance is used as a funding mechanism by a benefit plan sponsor. The benefit plan sponsor is a third party who pays for or in some other fashion enables benefits related to the life or health of an individual or individuals. The benefits provided by the benefit plan sponsor consist of cash payments designed to fund health, retirement, or death needs. Funding mechanisms which utilize life insurance benefits rely either on the cash values built up within a set of life insurance policies or the life insurance policies' death benefits to meet funding requirements for a benefit plan.

Benefit plans may be funded with the expectation of full or partial funding cost recovery via anticipated or expected death benefit proceeds from the life insurance policies. When death benefit proceeds are used to reduce or recover the cost attributable to benefit plans, it is important that the death proceeds be received in a predictable manner based on a set of mortality assumptions chosen by the benefit plan sponsor. Such chosen mortality assumptions, however, are often inaccurate due to the fact that the actual mortality experience for a selected group is difficult to determine because, generally, such data is not publicized by the insurance companies or reinsurance companies that collect the data.

Many benefit plans involving the use of life insurance policies as a funding vehicle do not take into account changes in the health status of the insured lives after the insurance policies were issued. That is, they do not rely for their value on the insured life becoming impaired. In order for life insurance policies to be an effective funding tool in programs in which death proceeds are the funding source, however, the death benefits actually received must be reasonably close to the death benefits expected based on the mortality assumptions used to set up the program.

It is well recognized that for the financial products created by the use of life insurance death proceeds as a funding vehicle, adverse financial consequences are created if the actual mortality experience of the lives insured under the life insurance policies being used is better than assumed. That is, adverse financial consequences are created for the third parties if the insured lives, as a group, live longer than expected. This can occur, for example, if a financial product is created by the purchase of a pool of life insurance policies insuring a group of insureds who have lives that are impaired at the time of purchase but who ultimately as a group live longer than expected. The investors providing the cash used to make these purchases are expecting a return on the money they have invested. The return the investors receive is derived from the death benefits that are paid on the life insurance policies that were purchased with the cash they provided. This return is expected to consist of the return of their invested principal plus an investment return. The amount of the investment return or income the investors receive is dependent on the amount and timing of the actual death benefit proceeds received from the group of policies purchased. A purchase price value is calculated for the policies being purchased which is based on mortality assumptions from which the timing and amount of expected future death proceeds can be projected. In addition, other expense and risk charge assumptions are typically made in order to determine a final purchase price for such life insurance policies.

Since it is the death proceeds of the group of policies purchased which provide the revenue to pay back to the investors their principal and a return on their investment, the actual death proceeds must be reasonably close to the expected death proceeds in amount and timing for the expected investment return to be realized. In a life settlement transaction, the investors would experience adverse financial consequences if the insured lives experienced better mortality as a group than the mortality assumption used to determine the purchase price for the policies.

Another example of when a set of insureds living longer than expected would have adverse financial consequences for a third party beneficiary, would be a situation in which a benefit plan's funding was dependent on the actual death proceeds from a life insurance policy or group of life insurance policies for which the insured or insureds health was not impaired. The benefit plan sponsor anticipates receiving life insurance policy benefits in an expected manner with respect to timing and amount. Such expectation would be based on the assumed level of mortality used in establishing the benefit plan's funding. Death benefit proceeds received by the plan sponsor later than expected, in lower amounts, or not at all would result in adverse financial consequences to the benefit plan sponsor since this would result in the benefit plan being under funded.

The financial risk that an owner of a life insurance policy or a third party beneficiary faces from a set of insured lives living longer than expected is referred to herein as a “survival risk”.

Insurance policies are purchased in the life settlement market by individuals or entities as investments. Such purchased policies may be placed into a life settlement pool in which many investors participate. The purchase price paid is such that the present value of the future death benefits expected from the policies in a life settlement pool exceeds the purchase price by the present value of investment income desired by the pool participants. Investors will receive their desired investment return if the actual experience of the life settlement pool is exactly as expected or assumed. If actual mortality experience is better than expected, then the investors were earn less than expected. If experience is worse, the investors will do better.

The risk to investors in a life settlement pool that mortality will be better than expected is referred to as “survival risk”. The need for a method of insuring against the adverse financial consequences of survival risk has been addressed in U.S. Pat. No. 6,999,935 entitled “Method of Calculating Premium Payment to Cover the Risk Attributable to Insureds Surviving a Specified Period” issued on Feb. 14, 2006. The Survival Risk Insurance (SRI) product described in that patent is an insurance product under which the risk of survival and the adverse financial consequences of survival longer than expected are transferred from one entity to another entity willing to accept that survival risk for a premium.

Mortality assumptions are used to calculate the purchase payment for life insurance policies in the life settlement market or to determine an investment share in a life settlement pool. For a premium, SRI transfers the risk that such mortality assumptions are better than expected from the investor to a survival risk insurance provider. This, thereby, makes life settlements a less risky investment to the investor.

### SUMMARY OF THE INVENTION

The Summary of the Invention is provided as a guide to understanding the invention. It does not necessarily describe the most generic embodiment of the invention or all species of the invention disclosed herein.

A new use for survival risk insurance is explained in the following.

Variable Life Insurance (VLI) is a form of life insurance in which the premiums paid by a policyowner are allocated by the policyowner to one or more Separate Accounts of the life insurance company. Variable Universal Life (VUL) insurance is a form of VLI (included in the category VLI) in which the premiums paid by the policyowner are flexible either in timing, frequency, or amount. The assets in each sub-account or division of the Separate Account are invested in shares of an underlying mutual fund. The Separate Account of the insurance company, if the VUL contract is available through a public offering, is registered as an investment company (typically a unit investment trust) under the Investment Company Act of 1940 (the 1940 Act).

VLI may also be offered in a form that is not part of a general public offering (not distributed by prospectus to the general public). Instead, it's a private offering, available only to qualified purchasers. These qualified purchasers are people of substantial economic means (as defined by federal securities laws) and are presumed to have investment savvy. The term private placement has been commonly used to describe this type of offering.

VLI insurance policies do not now but may include Separate Accounts that invest in Survival Risk Insurance (SRI) policies. Such investment in SRI would benefit the VLI policy owner when such owner was using the anticipated or expected VLI policy death benefit as a funding mechanism. The purchase of SRI by the Separate Account will guarantee a benefit whether or not the insured life lives or dies as expected.

Similarly, survival risk insurance may be purchased by an insurance company's General Account to assure that the death benefits provided by such insurer's traditional life insurance products (for example: traditional whole life or universal life) will either provide a death benefit per a schedule of death benefits projected by a model or will provide a survival benefit at a time when a death benefit was projected to be paid by the model. Such model would be a computer implemented calculation using assumptions, for example mortality and interest assumptions, to project the timing and present value of such death benefits. Such survival benefit is the benefit provided under the terms and conditions of a survival risk insurance policy.

A primary object of the invention is to provide a method to utilize survival risk insurance as an investment option within a variable life insurance contract Separate Account or a traditional life General Account in order to minimize or eliminate the survival risk to policyowners who may be using the policy death benefit as a funding strategy.

An entity (for example a corporation or a bank) may purchase VLI policies on lives on which the entity has an insurable interest. The premium paid into the contracts after deduction of any front end expenses or charges, which may be expressed as a percentage of the premium or as a fixed dollar charge per policy or per thousand of insurance in force, is the net premium. In VLI, the net premium is allocated by the policy owner, i.e. the purchasing entity, to one or more separate accounts. Per this invention, a portion of the assets in one or more of those separate accounts may be invested in survival risk insurance on one or more of such insured lives. As a result, the survival risk insurance provider will pay any survival risk benefit to such separate account(s) if the insured(s) live longer than expected.

In this funding strategy, the purchasing entity will be the beneficiary and receive the death benefit of the VLI life insurance policy if the insured dies while the policy is in force. Because the purchasing entity is the owner of the VLI contract, the purchasing entity is eligible to receive the policy assets invested in the separate account. This funding strategy depends on death benefits being paid from one or more of the VLI policies purchased by the entity per a projected schedule of death benefits. If insured lives live longer than expected at the time the funding strategy was initiated, then the expected death benefit cash flows will not be realized and the objectives of the funding strategy will not be met unless a portion of assets in the separate account(s) were used to purchase survival risk insurance.

The investment advisor for the VLI separate account, or others for the benefit of the investment advisor, would analyze, using the actuarial pricing methodologies described in the patents or patent applications incorporated by reference herein, the present value of future death benefits and an expected cash flow based on assumptions consistent with the risk characteristics of the lives insured for the policies owned by the purchasing entity. Such assumptions would consist of mortality, interest, expense, persistency, future premium payment requirements, and other assumptions as may be required in order to determine a fair and reasonable present value for such future death benefits.

Computer systems and programs would be used to apply such calculations individually to each insurance contract which is owned by the purchasing entity and, then, be summed in order to determine a total present value for all such insurance contracts. Such calculations may be done periodically in order to determine as of any given date a present value and cash flows as they may change from time to time.

Computer systems and programs would also be used by the investment advisor, or by others for the benefit of the investment advisor, in order to establish risk profiles for the life insurance policies on which survival risk insurance has been purchased by the separate account. Such risk profiles will include, for example, probabilities that the death benefit cash flows will develop as expected by the assumptions used to develop the funding strategies used by the purchasing entity and how likely it is that the projected investment return will be realized. Such risk evaluation may involve mathematically intensive stochastic processes in order to model a multitude of equally likely cash flow scenarios (for example, 1,000). The distribution of possible results produced by the model will be used to calculate the desired probabilities. Such stochastic process is efficiently carried out only on a computer using a system or program designed for such purpose.

In order to ameliorate the survival risk inherent in a purchasing entity's funding strategy, investment advisors may choose to purchase survival risk insurance on the lives insured by the purchasing entity for the benefit of the separate account. Such survival risk insurance will be purchased using a portion of the funds invested in the separate account. A number of survival risk insurance structures are possible as described in U.S. Pat. No. 6,999,935. One such structure would have the separate purchase survival risk insurance such that the survival risk insurance policy will pay a benefit to the separate account if a life insured by a policy owned by the purchasing entity survives a specified term which is at or near the term such life was expected to survive when his or her policy was purchased. The benefit paid by any such survival risk insurance policy will be paid to the separate account and, thereby, become part of the policy assets owned by the purchasing entity.

Through the purchase of survival risk insurance a separate account investing in one or more survival risk insurance policies can, for a premium or fee, transfer all or a portion of the survival risk inherent in any funding strategy. Thereby, an investment return or an expected funding result can be guaranteed or the probability of actually receiving a projected return or achieving an expected funding result can be significantly increased.

Another objective of the invention is to provide a way for insurance companies to transfer the risk they may assume in making guarantees to the policyowners to whom they have sold traditional life insurance that death benefits will be paid according to a predetermined schedule. Such schedule would be determined by using computer implemented model calculations to project death benefit payments per a set of assumptions, for example mortality and interest assumptions.

In this embodiment, the insurance company would purchase, using assets in its General Account, survival risk insurance payable to such General Account. The survival benefits paid under the terms and conditions of such survival risk insurance policies would fully or partially offset the payments made by the insurance company from its General Account as a result of such death benefit guarantees.

### BRIEF DESCRIPTION OF THE DRAWINGS

FIG. 1 is a diagram of an exemplary embodiment of the present invention.

FIG. 2 is a diagram of an alternative exemplary embodiment of the present invention.

### DETAILED DESCRIPTION OF THE INVENTION

The following detailed description discloses various embodiments and features of the invention. These embodiments and features are meant to be exemplary and not limiting.

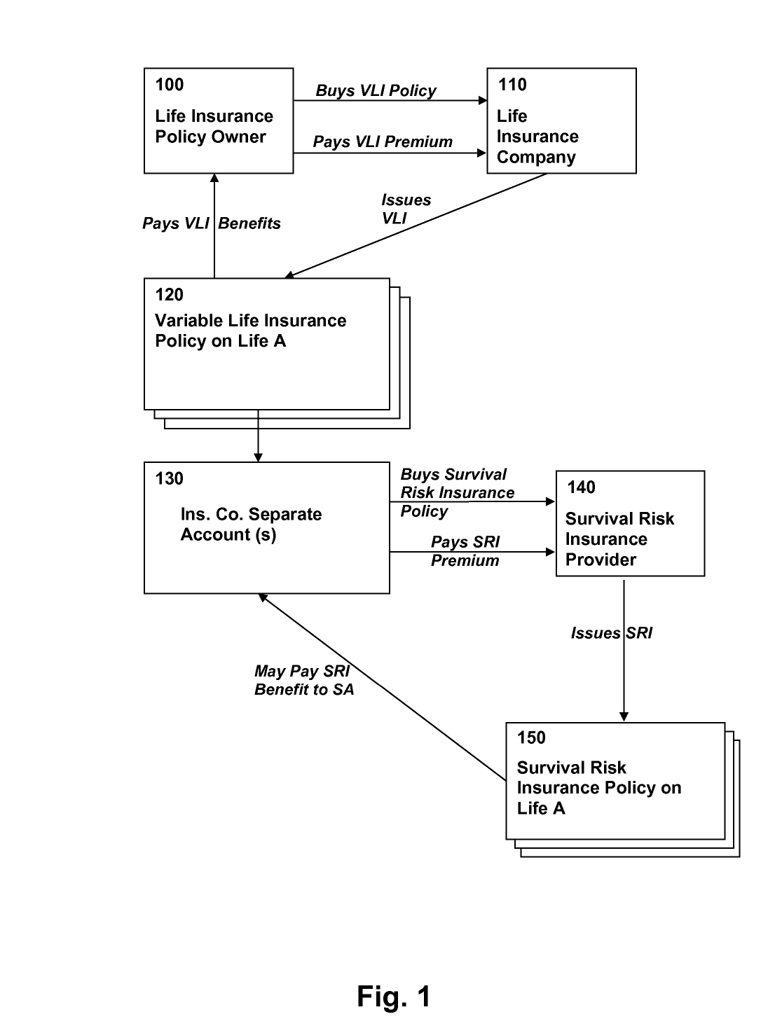

See FIG. 1 for a diagram of an exemplary embodiment of the present invention. The exemplary embodiment of the present invention comprises the following steps:
1. A purchasing entity 100 establishes a strategy for funding a program, such as a benefits program. The program has a cash flow requirement. The purchasing entity will rely on the timely payment of insurance policy death benefits to at least partially meet said cash flow requirement.
2. The purchasing entity will do calculations on a computer to model the expected timing and amount of said insurance policy death benefit payments under said funding strategy. The purchasing entity will use results from said computer model to determine the financial structure of said funding strategy, for example, the risks associated with the payment of said life insurance policy death benefits and the conditions under which the Survival Risk Insurance benefits will be purchased and paid into the Separate Account.
3. The purchasing entity becomes a policyowner by purchasing a variable life insurance (VLI) policy 120 from an insurer 110 on one or more lives on whom the policyowner has an insurable interest (insured lives). For example, the VLI policy issued 120 is on Life A. Said VLI contracts will pay to the policyowner, the purchasing entity, a death benefit if the insured life dies while the policy is in force and provides a cash value which can be accessed by the policyowner while the insured life is living.
4. The VLI policyowner 100 pays premiums to the insurance company 110 in order to keep the VLI contract 120 in force.
5. The premium paid to the insurer 110, net of any expense charges, is paid into the VLI contract and the policyowner makes choices which allocate the net premiums plus other assets to one or more Separate Accounts 130 established by the insurer.
6. If the insured life dies while the VLI insurance policy 120 is in force, the death proceeds are paid to the policyowner 100, i.e. the purchasing entity.
7. Per the terms, conditions, and management policy of the Separate Account 130 a portion of the Separate Account assets may be used by the Separate Account 130 to purchase a Survival Risk Insurance Policy 150 with respect to one or more of said Variable Life Insurance Policies 120. Said Survival Risk Insurance Policy 150 is provided by a Survival Risk Insurance Provider 140.
8. The Separate Account 130 pays a premium(s) to the Survival Risk Insurance Provider 140 for the Survival Risk Insurance (SRI) Policy 150 per the terms and conditions of such contract. A condition of issuing such SRI Policy 150 may be that the Survival Risk Insurance Provider 140 requires that the purchasing entity ensures the Survival Risk Insurance Provider will receive the VLI insurance policy 120 death benefit (or an amount equal to the survival risk benefit) following the Survival Risk Insurance Provider's payment of the survival risk insurance benefit.
9. The amount and structure of the SRI benefit is determined by the Separate Account investment advisor or insurance company based on risk analysis and modeling done by them or on their behalf utilizing said sophisticated computer modeling programs designed for that purpose.
10. The SRI policies purchased may be based on various characteristics, such as one or more of the following, in order to satisfy the risk transfer needs of the investment advisor:
   a) Distinct Specified Periods
   b) Varying amounts of Survival Risk Benefit
   c) Distinct insured age groups
   d) Different sex
   e) Different smoker status.
11. A survival risk insurance benefit is payable to the Separate Account 130 purchasing the SRI policy 150 based on the terms and conditions of the policy 150. Typically, the SRI policy 150 will pay a benefit if the insured life survives a specified period of time.

When the SRI benefits are paid into the Separate Account 130 which purchased the SRI policy 150 they are received as investment income and become part of the cash value of the variable life insurance policy 120.

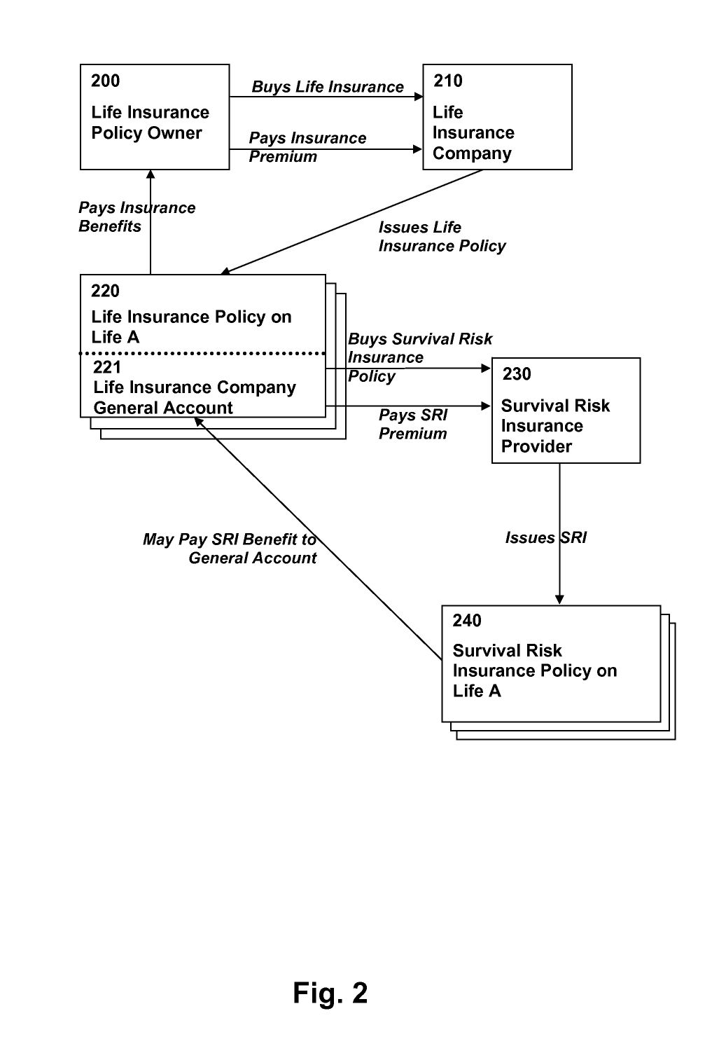

See FIG. 2 for a diagram of an alternative exemplary embodiment of the invention. The alternative exemplary embodiment of the present invention comprises the following steps:
1. A purchasing entity 200 establishes a strategy for funding a program, such as a benefits program. The program has a cash flow requirement. The purchasing entity will rely on the timely payment of insurance policy death benefits to at least partially meet said cash flow requirement.
2. The purchasing entity will do calculations on a computer to model the expected timing and amount of said insurance policy death benefit payments under said funding strategy. The purchasing entity will use results from said computer model to determine the financial structure of said funding strategy, for example, the risks associated with the payment of said life insurance policy death benefits and the conditions under which the Survival Risk Insurance benefits will be purchased and paid into the General Account.
3. The purchasing entity, becomes a policyowner by purchasing a life insurance policy 220 from an insurer 210 on one or more lives on whom the policyowner has an insurable interest (insured lives). For example, the life insurance policy issued 220 is on Life A. Said life insurance policy contracts will pay to the policyowner, the purchasing entity, a death benefit if the insured life dies while the policy is in force and provides a cash value which can be accessed by the policyowner while the insured life is living.
4. The life insurance policyowner 200 pays premiums to the insurance company 210 in order to keep the life insurance contract 220 in force.
5. The premium paid to the insurer 210, net of any expense charges, is paid into the General Account 221 of the life insurance company.
6. If the insured life dies while the life insurance policy 220 is in force, the death proceeds are paid to the policyowner 200, i.e. the purchasing entity.
7. Per the terms, conditions, and management policy of the General Account 221 a portion of the General Account assets may be used to purchase a Survival Risk Insurance Policy 240 with respect to one or more of said Variable Life Insurance Policies 220. Said Survival Risk Insurance Policy 240 is provided by a Survival Risk Insurance Provider 230.
8. The General Account 221 pays a premium(s) to the Survival Risk Insurance Provider 230 for the Survival Risk Insurance (SRI) Policy 240 per the terms and conditions of such contract. A condition of issuing such SRI Policy 240 may be that the Survival Risk Insurance Provider 230 requires that the purchasing entity ensures the Survival Risk Insurance Provider will receive the life insurance policy 220 death benefit (or an amount equal to the survival risk benefit) following the Survival Risk Insurance Provider's payment of the survival risk insurance benefit.
9. The amount and structure of the SRI benefit is determined by the General Account investment advisor or insurance company based on risk analysis and modeling done by them or on their behalf utilizing sophisticated computer modeling programs designed for that purpose.
10. The SRI policies purchased may be based on various characteristics, such as one or more of the following, in order to satisfy the risk transfer needs of the investment advisor:
   a) Distinct Specified Periods
   b) Varying amounts of Survival Risk Benefit
   c) Distinct insured age groups
   d) Different sex
   e) Different smoker status.
11. A survival risk insurance benefit is payable to the General Account 221 purchasing the SRI policy 240 based on the terms and conditions of the policy 240. Typically, the SRI policy 240 will pay a benefit if the insured life survives a specified period of time.

When the SRI benefits are paid into the General Account 221 which purchased the SRI policy 240 they are received as investment income and become part of the cash value of the life insurance policy 220.

The terms and conditions of the life insurance policy 220 will be designed, as is typical for VLI policies issued in the insurance industry, such that the VLI policy qualifies as life insurance under US Internal Revenue Code section 7702 or other appropriate code in a given jurisdiction.

### CONCLUSION

One of skill in the art will recognize that insurance is a regulated industry. One practicing the methods described and claimed herein will want to maintain compliance with all applicable local, state and federal regulations, to ensure that the insurance policy is properly presented to the insured, premiums are properly approved, underwriting properly occurs, all necessary regulatory approvals are in place, etc.

While particular embodiments of the present invention have been illustrated and described, it would be obvious to those skilled in the art that various other changes and modifications can be made without departing from the spirit and scope of the invention. Any of the aspects of the present invention found to offer advantages over the state of the art may be used separately or in any suitable combination to achieve some or all of the benefits of the invention disclosed herein.

What I claim is:

1. A method for a purchasing entity to fund a program relying on insurance policy death benefits, said program having a cash flow requirement, said method comprising the steps:
a) purchasing one or more variable life insurance policies from an insurance company on one or more lives on which said purchasing entity has an insurable interest, said one or more variable life insurance policies comprising a Separate Account, and wherein said life insurance policies:
i) are owned by said purchasing entity, and
ii) provide that life insurance benefits may be fully or partially payable to said purchasing entity;
b) paying the premiums required by the insurance company to keep said one or more variable life insurance policies in force;
c) requiring that said Separate Account has terms, conditions, and a management policy that allows said Separate Account to purchase Survival Risk Insurance with respect to at least one of said one or more variable life insurance policies from a Survival Risk Insurance provider with survival risk benefits that will be paid to said Separate Account; and
d) calculating on a computer
i) the expected timing and amount of payment of said life insurance benefits to said purchasing entity; and
ii) the amount and conditions under which said Survival Risk Insurance benefits will be paid to said Separate Account; and
e) determining whether or not said payment of said life insurance benefits and the funds in said Separate Account will meet said cash flow requirement.

2. The method of claim 1 wherein said Survival Risk Insurance is categorized into distinct underwriting classes based on one or more of the following characteristics:
a) the specified period of the survival risk insurance policy;
b) the amount of survival risk benefit;
c) the age of the insured lives;
d) the sex of the insured lives; and
e) whether or not the insured lives smoke.

3. The method of claim 1 wherein said purchasing entity contracts with said Survival Risk Insurance provider to assign its interest in the death benefit of said variable life insurance policies to said Survival Risk Insurance provider with respect to any insured life on whom a survival risk benefit has been paid by said Survival Risk Insurance provider.

4. A method for a purchasing entity to fund a program relying on insurance policy death benefits, said program having a cash flow requirement, said method comprising the steps:
a) purchasing one or more life insurance policies from an insurance company on one or more lives on which said purchasing entity has an insurable interest, wherein said one or more life insurance policies invest in the General Account of said insurance company and wherein said life insurance policies:
i) are owned by said purchasing entity;
ii) contain an option, benefit, or rider that guarantees that either the death benefit or an amount equal to the death benefit will be paid on a date determined at the time the insurance policy was issued either fully or partially to said purchasing entity; and
iii) provide that life insurance benefits may be fully or partially payable to said purchasing entity;
b) paying the premiums required by the insurance company to keep said one or more life insurance policies in force;
c) requiring that said General Account has terms, conditions, and a management policy that allows said General Accounts to purchase Survival Risk Insurance with respect to at least one of said one or more variable life insurance policies from a Survival Risk Insurance provider with survival risk benefits that will be paid to the General Account; and
d) calculating on a computer
i) the expected timing and amount of payment of said life insurance benefits to said purchasing entity; and
ii) the amount and conditions under which said Survival Risk Insurance benefits will be paid to said General Account; and
e) determining whether or not said payment of said life insurance benefits and the funds in said General Account will meet said cash flow requirement.

5. The method of claim 4 wherein said purchasing entity contracts with said Survival Risk Insurance provider to assign its interest in the death benefit of said life insurance policies to said Survival Risk Insurance provider with respect to any insured life on whom a survival risk benefit has been paid by said Survival Risk Insurance provider.
